(19) United States
(12) Patent Application Publication
(10) Pub. No.: US 2011/0158222 A1
(43) Pub. Date: Jun. 30, 2011

(54) CELLULAR TELEPHONE SYSTEMS WITH SUPPORT FOR CONVERTING VOICE CALLS TO DATA SESSIONS

(76) Inventors: Duncan Kerr, San Francisco, CA (US); David Falkenburg, San Jose, CA (US); Aaron Leiba, San Francisco, CA (US)

(21) Appl. No.: 12/648,279

(22) Filed: Dec. 28, 2009

(51) Int. Cl. H04L 12/66; H04W 4/00; G06F 15/16

(52) U.S. Cl. 370/352; 455/414.1; 709/227

(57) ABSTRACT

Wireless electronic devices such as cellular telephones may communicate with computing equipment such as servers over a network. Voice telephone calls may be routed over voice links in a voice network and data may be conveyed over data links in a data network. The voice network may be formed using the public switched telephone network. The data network may be formed using the Internet. Cellular base stations may form wireless links with the wireless devices. A server may store information on the current internet protocol address of a wireless device user. The user may place a voice telephone call to an organization. In response to receiving the voice telephone call, a server may automatically transmit information such as web pages or other data that includes interactive on-screen options to the wireless device using the current internet protocol address of the device.

### BACKGROUND

This relates to wireless communications systems, and more particularly, to cellular telephone systems with support for voice calls and data services.

Many modern cellular telephone have the ability to support data services. For example, many cellular telephones allow users to browse the web and receive email messages.

Although these data services are available, users often find it to be more convenient to interact with organizations using traditional voice telephone calls.

Consider, as an example, the process of obtaining support for a newly purchased product. After experiencing technical difficulties with a new purchase, a user may be frustrated and need help. Organizations that sell complex products typically have websites that contain lists of frequently asked questions, online troubleshooting guides, online forums, and product manuals. In some situations, a user might choose to obtain support information by using a web browser to browse the website of the organization. Often, however, a frustrated user may be intimidated by the wealth of information available on a website and the perceived difficulty of accessing this information through a cellular telephone. As a result, the user may simply place a voice call to a telephone support number.

Calls to the telephone support number may initially be handled by an interactive voice response system at the organization. The interactive voice response system may play a prerecorded list of options for the user. These options may help the interactive voice response system route the user's call to an appropriate customer service representative. Interactive voice response systems may ask a user to select between inquiries related to new purchases and inquiries related to previously purchased products. These systems may also ask a user to choose a produce type from a list of products. In some systems, users are asked to enter serial numbers or other information that indicates that the user is an authorized customer of the organization or that provides the organization with information that might be used in troubleshooting the user's problem.

While the initial process of placing the voice call to the customer support number is straightforward, the subsequent interactions of the user with the interactive voice response system can be cumbersome. The user is often forced to listen to long lists of menu options before a menu option that is pertinent to the user's problem is presented. It can also be difficult for a user to supply numbers and other data during the voice call. Some systems use a computerized voice to play back a user's entries for double-checking, but this requires careful attention on the part of the user.

Because of these issues, users may be displeased with voice-based customer support. Organizations can attempt to improve service by providing large numbers of customer support representatives who manually answer each incoming phone call, but this approach may not be economically feasible.

It would therefore be desirable to be able to better exploit the data link and voice link capabilities of wireless devices such as cellular telephones.

### SUMMARY

Wireless electronic devices such as cellular telephones may communicate with computing equipment over a network. The computing equipment may include a server associated with an organization and a server associated with a registration service.

The organization may be a company that sells products or services. The organization might desire to provide cellular telephone users with directory information or other information services. The organization might also desire to provide customer support for a cellular telephone user who has purchased a cellular telephone or other product from the organization.

A user of a cellular telephone may sometimes browse the Internet using the data capabilities of the cellular telephone. In other situations, the user may prefer to make a voice call to an organization.

An organization may have a server or other computing equipment that runs an interactive voice response service with interactive data capabilities. When a voice call is received from a user of a cellular telephone, the service may respond by automatically transmitting data such as interactive on-screen options data or streaming media to the cellular telephone over a data link.

In transmitting this data to the cellular telephone, the service may use the network address of the cellular telephone. The network address may be obtained from a database. For example, as a cellular telephone user is using a cellular telephone, the current network address of the cellular telephone can be periodically uploaded to a network address registration service. When a user calls an organization, the organization may use a caller identification (caller ID) service such as a caller ID service provided by a telecommunications service provider to ascertain the cellular telephone number that is associated with the cellular telephone of the user. Based on this cellular telephone number or other cellular telephone identification information, the organization may formulate a network address request. The network address request may be sent to a network address registration service over the Internet (as an example). Network address information may also be obtained from a telecommunications service provider.

If desired, the computing equipment of the organization may take steps to ascertain whether a cellular telephone that has placed a voice call to the organization has data capabilities before attempting to ascertain the network address of the telephone. The computing equipment may, for example, consult a list of pre-registered telephones. As another example, the computing equipment may exchange audible chirps, beeps, or other audio codes with the cellular telephone. Once the data handling capabilities of the cellular telephone have been confirmed by this exchange of information, the computing equipment may proceed to obtain the IP address of the cellular telephone.

The organization may be a company that sells products or services. When a user calls the organization, the organization can present the user with interactive screens of options. The options may be displayed automatically or may be displayed after the user has responded affirmatively to a voice prompt or other query from the organization. The on-screen options may include options to select items for purchase, options to place an order, etc.

The organization may provide customer support for purchased products. When a user calls the organization, a data link with the cellular telephone of the user may be established. The user may be presented with menu options that allow the user to bypass some or all of the interactive voice response system audible menu prompts that an organization provides to callers whose telephones cannot handle data links. If desired, support personnel at the organization may conduct a remote access session with the cellular telephone to assist the user.

A user of a cellular telephone might desire to obtain telephone directory information or other information from an organization. The user may initially contemplate receiving the information over a normal voice telephone call. The user may therefore place a voice call to an organization. When the organization determines that the user's cellular telephone is capable of receiving and displaying data, the organization may form a data link with the cellular telephone. The data link may be used to receive directory request information from the user and may be used to display requested information for the user.

A user may need to contact an organization to activate a credit card or perform other financial account transactions. When the user places a voice call to the organization, the organization may transmit data pages to the user's cellular telephone that include text entry boxes. The user may enter credit card information or other financial information into a text box for submission to the organization. The submitted information may be used to activate a credit card or to perform other financial or business transactions.

Further features of the invention, its nature and various advantages will be more apparent from the accompanying drawings and the following detailed description of the preferred embodiments.

### BRIEF DESCRIPTION OF THE DRAWINGS

FIG. 1 is a circuit diagram of a system that may include cellular telephones and services that allow users to use voice and data communications when interacting with an organization in accordance with an embodiment of the present invention.

FIG. 2 shows an illustrative display screen that may be presented to a user by an online service that accepts product orders after the user has placed a voice call to the service in accordance with an embodiment of the present invention.

FIG. 3 shows illustrative display screens that may be presented to a user by an online service that provides customer support in accordance with an embodiment of the present invention.

FIG. 4 shows illustrative display screens that may be presented to a user by an online service that provides telephone directory information in accordance with an embodiment of the present invention.

FIG. 5 shows illustrative display screens that may be presented to a user by an online service that allows users to activate their credit cards in accordance with an embodiment of the present invention.

FIG. 6 is a flow chart of illustrative steps involved in operating a system of the type shown in FIG. 1 to provide services of the type illustrated in FIGS. 2, 3, 4, and 5 in accordance with an embodiment of the present invention.

### DETAILED DESCRIPTION

Use of the telephone in modern society is ubiquitous. People use telephones to check the times at movie theaters, to contact customer support services, to access telephone directory information, to place orders with restaurants, to make mail order purchases, etc.

With the advent of cellular telephones, telephone use has become even more widespread. For example, it is not uncommon for a user to call a business to place an order for a product even when the user is not calling from the user's home or other location at which a landline phone is available.

Recently, cellular telephones have become available that support data services in addition to voice calls. These data services include communications services such as email and instant messaging. Web browsing on cellular telephone is also popular. Some cellular telephones allow users to download applications. These applications sometimes include data functions. For example, an application may be dedicated to providing a user with real time information on particular products or services.

Despite the widespread use of cellular telephones to deliver data services, there are limitations. Some users are conditioned by habit. For example, even if it is theoretically possible to obtain telephone directory information by launching a web browser on a cellular telephone and visiting an online directory service website, users who have years of experience in obtaining directory service information using landline phones may be more comfortable in placing a voice call to a traditional telephone directory service number than in using the web browser. Similarly, many users know the phone numbers of their favorite restaurants and mail order companies by heart and therefore find it easy to place a call to contact those businesses. Web based information may be available, but users may avoid using a web browser on a telephone screen when a more familiar voice-based call might suffice.

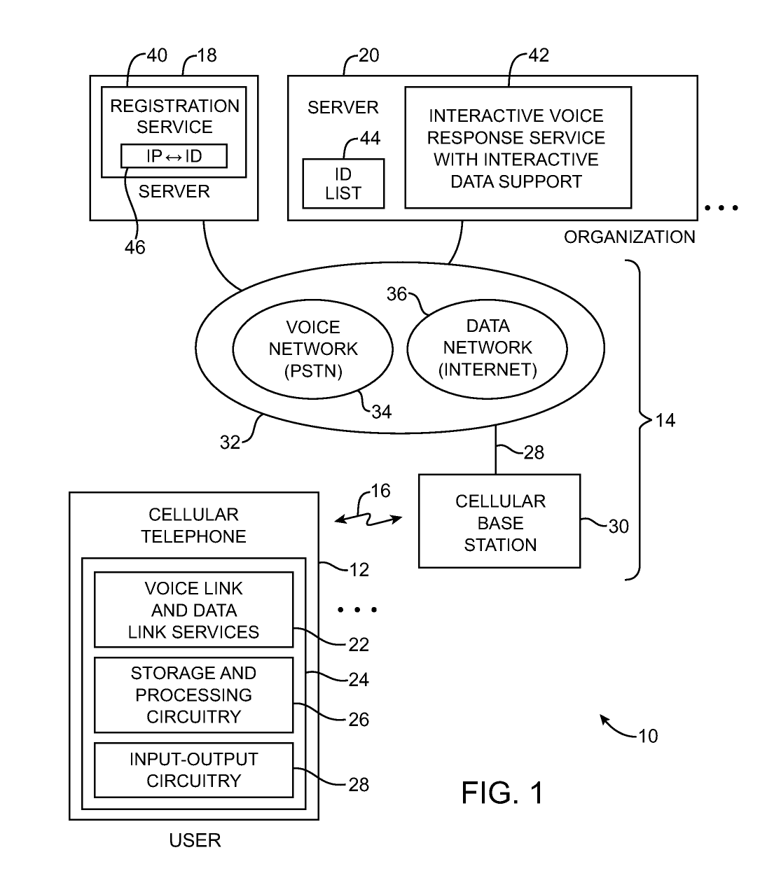

A system of the type shown in FIG. 1 may assist users who make voice telephone calls such as these using cellular telephones that are capable of handling data services. Users may have cellular telephones 12 that communicate with online services over network 14. Services may be provided by organizations using computing equipment such as server 20 and server 18. Servers 18 and 20 may communicate with user equipment such as cellular telephones 12 or other wireless devices using network 14.

A user may initiate contact with an organization by placing a voice telephone call. After the call has been placed, the presence of an interactive data interface and other data-handling capabilities in the user's cellular telephone may be automatically detected. Once the system has determined that the user's cellular telephone is capable of receiving and displaying screens of data, this functionality can be exploited to assist the user.

For example, screens of selectable options and other information may be automatically displayed for the user on the cellular telephone. These on-screen options may correspond to menu options or other information that would normally be played back to the user as part of a voice call. Because the visual capabilities and other advanced capabilities of the user's cellular telephone are used, many of the shortcomings associated with interacting with organizations during voice telephone calls can be avoided.

Cellular telephones 12 may include voice link services and data link services (shown collectively as voice link and data link services 22). These services may be used to maintain voice links and data links. Voice telephone calls with landline and cellular telephones may be supported using the voice link services of services 22. Data links such as packet-based communications links using the Internet or other packet-based networks may be supported using the data link services of services 22.

Services 22 may run on circuitry 24. Circuitry 24 may include storage and processing circuitry 26 and input-output circuitry 28. Storage and processing circuitry 26 may include volatile and nonvolatile memory. For example, storage and processing circuitry 26 may contain random-access-memory circuits, non-volatile memory chips, hard disk drives, solid state drives, and removable media. Processing circuitry in cellular telephone 12 may be based on one or more microprocessors, microcontrollers, digital signal processors, application-specific integrated circuits, radio-frequency processors, transceivers, etc.

Input-output circuitry 28 may be used to receive user input and to supply output. Input-output circuitry 28 may contain user input interface devices such as buttons, touch screens and other displays, keyboards, keypads, trackpads, etc. Input-output circuitry 28 may also include audio ports, digital data ports, power ports, and other input-output ports. Wireless circuitry in input-output circuitry 28 may be used to transmit and receive radio-frequency signals. The wireless circuitry of input-output circuitry 28 may include a baseband processor, radio-frequency transceiver circuitry, power amplifier circuitry, low noise amplifier circuitry, antennas, etc.

In the FIG. 1 example, equipment 12 has been implemented as a cellular telephone. This is, however, merely illustrative. In general, a user may have any suitable wireless user equipment that communicates with network 14. User equipment (device 12) in system 10 may, for example, be based on a computer, a laptop computer, a tablet computer, a handheld computing device, etc. At least part of the circuitry of device 12 is typically used for voice telephone calls, so scenarios in which equipment 12 is implemented as a cellular telephone are described herein as an example.

Cellular telephone 12 may communicate wirelessly with network 14 over wireless communications path 16. In particular, cellular telephone 12 may be wirelessly linked with cellular base station 30 of network 10. Cellular telephone base station 30 may be interconnected with portion 32 of network 14 via path 38.

Network 32 may include voice network equipment and data network equipment. The voice network portion of network 14 is typically referred to as the public switched telephone network (PSTN). The PSTN contains telephone switches (e.g., Class 4 telephone switches, Class 5 telephone switches, hybrid Class 4/5 switches, etc.) and other network infrastructure that handles traditional voice telephone call operations. Voice network 34 may, for example, handle functions such as receiving and processing a dialed telephone number, forming a corresponding voice link between the calling equipment and the called party, handling caller identification (caller ID) functions, supplying call information to associated telephone billing systems, etc.

Data network 36 is used for handling data links. Network 36 may include or be based on the Internet or other packet-based data networks. Packet-based switches (routers) may be used to route traffic in network 36. Unlike network 34, where voice links are formed based on voice telephone numbers, communications links in network 36 are formed using network addresses. For example, data packets may be routed based on Internet Protocol (IP) addresses.

Organizations in system 10 may be reached using voice network 34. For example, a user may place a voice telephone call to a business by dialing an appropriate telephone number using a keypad in cellular telephone 12. The equipment of voice network 34 routes the telephone call to equipment at the organization that is capable of handling voice calls. This equipment is shown as server 20 in the example of FIG. 1. Server 20 may be used to support services such as service 42 (i.e., an interactive voice response service with interactive data support) and may be used to maintain one or more databases (e.g., a database that includes identifier list 44).

Server 20 may be formed from one or more computers or other computing equipment and may be located at one or more different locations. Third party services may be used to implement some or all of the computer functions of server 20 for an organization. As an example, a server such as server 18 that is associated with a third party service or other service may be used to implement registration service 40. Registration service 40 may maintain one or more databases (e.g., a database that includes list 46). Lists such as lists 46 and 44 may be used in identifying the network addresses of cellular telephones 12 in system 10. For example, server 18 may maintain a database that includes registered internet protocol addresses for cellular telephones in system 10 and other wireless devices in system 10 that receive data over data links in data network 36 using cellular base stations such as cellular base station 30.

To make a voice call from cellular telephone 12, a user manually enters a telephone number or selects a telephone number from an address book or other list of numbers in cellular telephone 12. Services 22 in telephone 12 place the call. Cellular base station 30 and PSTN 34 route the call to service 42. Service 42 receives the voice call and provides the user with corresponding data-based services over data network 36. In supporting these data services to the user, service 42 provides cellular telephone 12 with data such as interactive on-screen options, screens of data such as web pages, streaming media, options to download applications and other data, etc.

Service 42 uses the network address of cellular telephone 12 when transmitting data over network 36. With one suitable arrangement, service 42 may obtain the network address of cellular telephone 12 from network address registration service 40. Periodically, cellular telephone 12 may report its current IP address to service 40. Cellular telephone 12 may also provide service 40 with a corresponding identifier (ID). The ID may be based on a serial number, user name, telephone number, or other information that uniquely identifies cellular telephone 12. Service 40 may store the ID of the cellular telephone and the IP address of the cellular telephone in list 46. When service 42 desires to establish a data link with cellular telephone 12, service 42 may request the user's current IP address from service 40 over network 36.

In making this request, service 42 may supply the ID for which the IP address is requested. The ID may be obtained manually by asking the user of cellular telephone 12 to enter the ID or associated information such as the user's telephone number using the keypad of cellular telephone 12 or to state the ID or associated information using the user's voice. A username and password scheme may, if desired, be used to identify the user and the user's cellular telephone.

It may be advantageous to obtain the user ID automatically. Accordingly, the ID may, if desired, be obtained by using a caller identification (caller ID) function (service) in network 34 to automatically ascertain the telephone number of cellular telephone 12. The telephone number may then be used to look up the ID for the cellular telephone in list 44 or the telephone number may be used as the ID. List 44 may be created by the organization associated with service 42 (e.g., when cellular telephone 12 is initially sold to the user) or may be populated through a user registration process. After the ID is obtained, service 42 may obtain the IP address of cellular telephone 12 by requesting the IP address from service 40.

With another suitable arrangement, service 42 may ask the telecommunications service provider that is associated with supporting wireless link 16 for the current IP address of cellular telephone 12 or may ask the service provider to establish a data link between service 42 and cellular telephone 12.

If desired, service 42 can check to determine whether cellular telephone 12 is capable of handling data link communications (e.g., before attempting to establish a data link). This checking process may involve the transmission of audio codes between service 42 and services 22 on cellular telephone 12. As an example, when service 42 receives an incoming voice call from network 34, service 42 may produce an audio code (e.g., a particular chirp, or series of beeps of one or more suitable frequencies). This audio code may be transmitted to cellular telephone 12 over the voice link in voice network 34. Services 22 in cellular telephone 12 can recognize the audio code from service 42 and can send a confirmatory audio code to service 40 over the same voice link. With an alternative arrangement, the audio code communications process can be initiated by cellular telephone 12 and service 22. When service 42 is able to identify cellular telephone 12 in list 44 (e.g., from caller ID or user-supplied identification information), the transmission of the audio codes to confirm the data-link compatibility of cellular telephone 12 need not be performed. Data link compatibility testing also need not be performed if the user manually informs service 42 that cellular telephone 12 is capable of receiving data link communications (e.g., by responding to a voice prompt from service 42 such as “say yes if your phone can handle data services”).

In processing the call received from cellular telephone 12, service 42 can perform the functions of a traditional interactive voice response system. For example, service 42 can play audible menu items, hold music, etc. As the user presses buttons on the keypad of cellular telephone 12, service 42 can respond accordingly (e.g., by routing the voice call to an appropriate customer service representative at the organization). However, unlike conventional interactive voice response systems, service 42 can also send data to cellular telephone 12 over data network 36 and can receive corresponding transmitted data from cellular telephone 12 over data network 36.

The data that is conveyed between service 42 and cellular telephone 12 may be used to display information for the user of cellular telephone 12. For example, service 42 may send a web page or other display screen of information for viewing by the user. The data to be displayed might contain directions, a list of food items available at a restaurant, a list of services available at an online service provider, a list of products available for purchase at a mail order store, a list of applications to purchase and download, graphs, charts, maps, images, text, graphics, video, etc.

The displayed data may be interactive. For example, a web page or other set of displayed data may contain user-selectable on-screen options. The options may correspond to items in a menu (i.e., a menu of the type that would normally be provided by an interactive voice response service), options to purchase a service, options to download an application, options to place a voice call, options to browse to a particular web site, options to receive an email or other message, options to place an order that is to be picked up in a store, options to proceed to different sets of on-screen options, options that allow users to respond to questions, options that allow users to upload data, etc.

If desired, the data link between service 42 and cellular telephone 12 may be used to provide streaming content (e.g., music, video, interactive graphics, etc.).

The streaming content may be part of a static display of text and/or graphics or may occupy the entire display of cellular telephone 12.

A customer service representative or other personnel associated with the organization at which service 42 is operating may use service 42 to initiate a remote access (“remote desktop”) session for the cellular telephone. With this type of arrangement, the computer or other equipment of the customer service representative (computing equipment 20 or associated computing equipment) may display a replica of the currently displayed content on cellular telephone 12. The customer service representative may use the remote access session to change settings on cellular telephone 12 and to otherwise interact with cellular telephone 12 (e.g., to help a user overcome a technical problem).

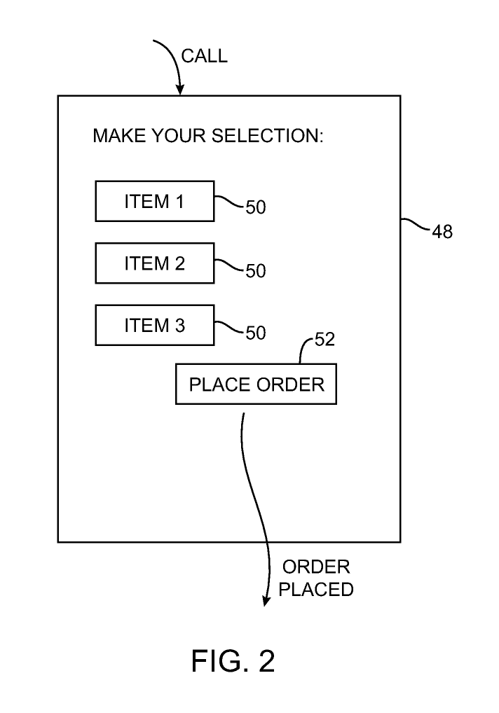

System 10 of FIG. 1 may be used to support product ordering. Consider, as an example, a user who calls a restaurant or other brick-and-mortar business or who calls an online business. As shown in FIG. 2, when the call is received, the business may use service 42 to display a screen such as screen 48 on the user's cellular telephone. Screen 48 may contain on-screen options such as options 50 and 52. A user may use a set of cursor keys, a touch screen, or other user interface to highlight one of options 50 and thereby select a desired product or service to purchase. After selecting desired items, the user may select place order option 52 (e.g., by touching option 52 in an touch screen environment or by using other appropriate option selection techniques). In response to selection of option 52, service 42 at the business can initiate order processing.

An arrangement of the type shown in FIG. 2 might be used, for example, to facilitate product ordering at a busy online retailer. A user may initially attempt to call the retailer to place a catalog order. When the user reaches the business through voice network 34, service 42 may play a prompt for the user such as “thank you for calling, our wait time is 10 minutes.” At the same time, service 42 can push a screen of options such as screen 48 onto the user's display. The user may be presented with an opportunity to “opt-in” to the data link session or may be provided with screen 48 automatically.

If the decides it would be quicker to order through the on-screen data session, the user can choose among the available options. Screen 48 may be provided in the form of a web page or other suitable collection of interactive screen elements. Multiple layers of options may used to provide the user with a wide range of ordering choices. Products that have been ordered in this way may be mailed to the user. Media products and downloadable software applications may, if desired, be downloaded to cellular telephone 12 or other equipment over network 14. Purchased services can be fulfilled wherever appropriate.

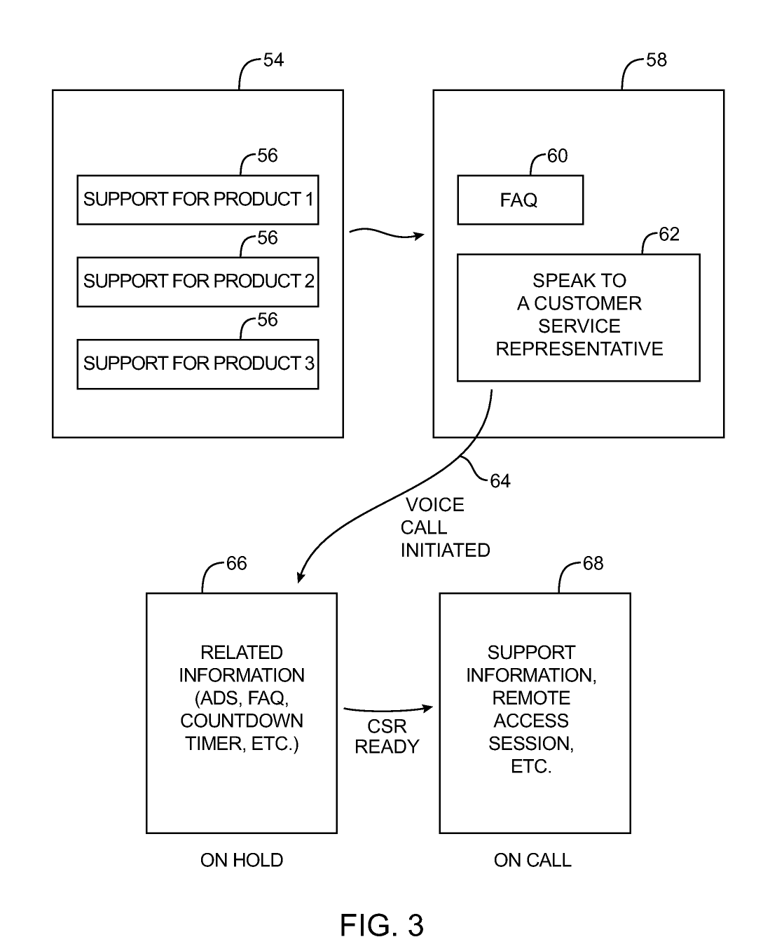

Another illustrative arrangement for using system 10 is shown in FIG. 3. As shown in FIG. 3, after a user has placed a voice call to an organization, service 42 at the organization may send data screen 54 to the user's cellular telephone. The organization may be a company from which the user purchased a produce such as cellular telephone 12. The phone number to which the user placed the voice call may be the customer support number for the organization. Screen 54 may contain interactive options 56. A user can select a desired one of option 56 to receive support for a particular product or topic. When the user selects a desired option, data that is indicative of which option was selected is received from the user's cellular telephone at service 42 over data network 36. Service 42 can then display a screen such as screen 58 on cellular telephone 12.

As shown in the example of FIG. 3, screen 58 may contain frequency-asked-questions option 60 and speak to a representative option 62. A user may select option 60 to obtain text and other information regarding products. If the user selects option 62, cellular telephone 12 and service 42 may establish a voice link (or a voice over IP link using network 36) between the user and an appropriate customer service representative, as indicated by line 64. While waiting for the customer service representative to answer this call, the user may be presented with hold music, advertisements, a countdown timer indicating how much time remains before the call will be answered, or other suitable information (screen 66). Once the call is answered by the customer service representative, a screen such as screen 68 may be presented. Screen 68 may correspond, for example, to the cellular telephone end of a remote access session in which the customer service representative takes remote control of cellular telephone 12 to assist the user. If desired, the user may be presented with an on-screen option that allows the user to confirm that remote access is permitted before proceeding with the remote access session.

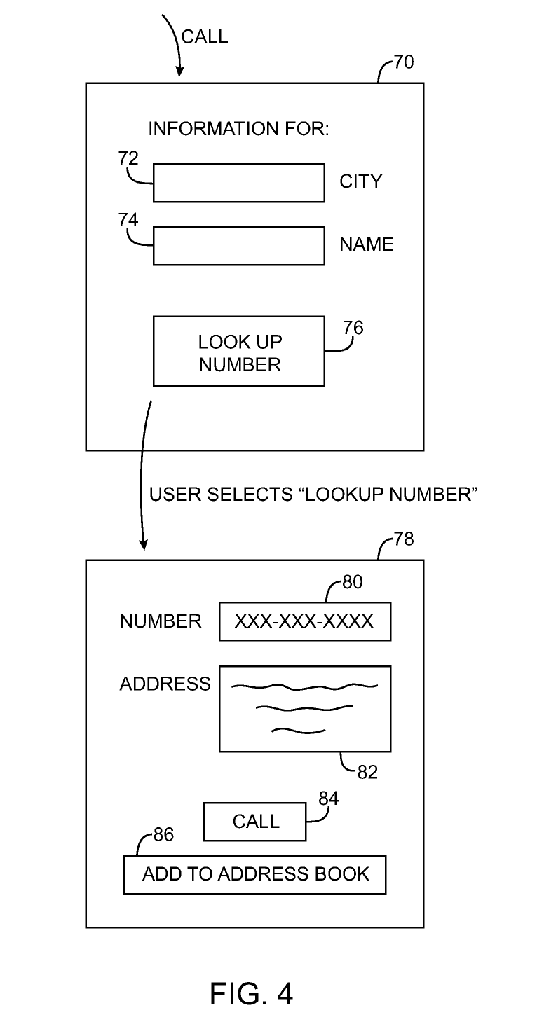

Another illustrative usage scenario for system 10 is shown in FIG. 4. As shown in FIG. 4, a user may place a call to a telephone directory number. Callers without data capabilities on their cellular telephones can interact with the service by voice (e.g., by speaking to a representative or computer and/or pressing keys). The user of cellular telephone 12 of FIG. 1 may be presented with a screen such as screen 70 of FIG. 4. Screen 70 may contain text entry boxes 72 and 74 or other interactive options that allow the user to specify the city and name of the person or business for which information is sought. Once this information has been entered (e.g., using a pop-up virtual keyboard on a touch screen on cellular telephone 12), the user may select “look up number” option 76. In response, the user may be presented with results from service 42. In particular, service 42 may use the data supplied by the user via screen 70 to perform a database search and may provide screen 78 to the user. Screen 78 may contain search results such as the telephone number for the entity specified in options 72 and 74 of screen 70 (shown as telephone number 80) and information on the address of this entity (address 82). Screen 78 may also include selectable on-screen options such as options 84 and 86. A user may select option 86 to add number 80 and address 82 to the address book in cellular telephone 12. Selection of call option 84 will direct cellular telephone 12 to place a voice call to number 80.

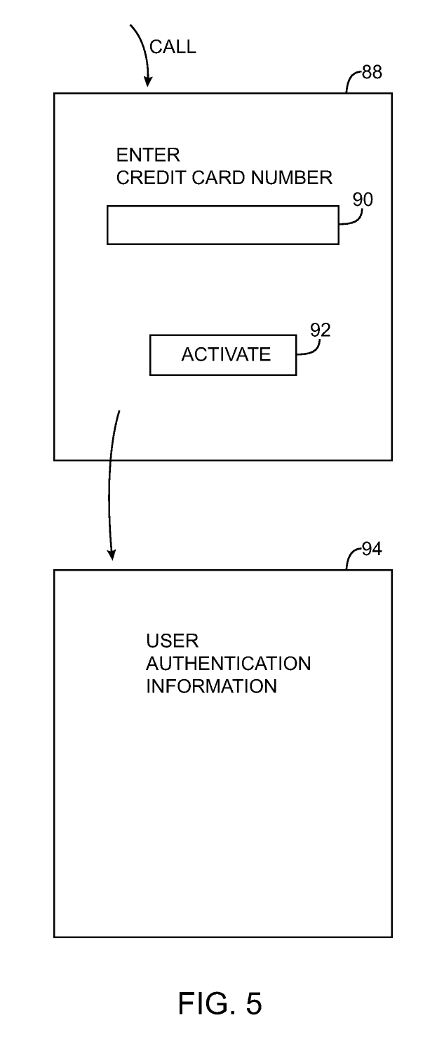

FIG. 5 illustrates a scenario in which a user receives a new credit card in the mail and needs to activate the card prior to use. The credit card may be provided with a sticker that informs the user of an appropriate voice telephone number to call. When the user places the voice call to the printed number, service 42 at the credit card company detects that cellular telephone 12 has data capabilities and displays a screen such as screen 88 for the user. Screen 88 may contain a text entry box such as box 90 or other option that allows the user to enter the credit card number for the credit card. The user may then select option 92 to proceed with the activation process. Service 42 may verify information associated with the user to determine whether or not to activate the credit card. For example, service 42 can use caller ID to determine whether cellular telephone 12 is associated with the cardholder of record (in which case the card can be activated) or can ask the user to provide additional authentication information. Screens such as screen 94 may be used, for example, to gather social security number information, username and password information, or other information that verifies that the user is authorized to activate the credit card.

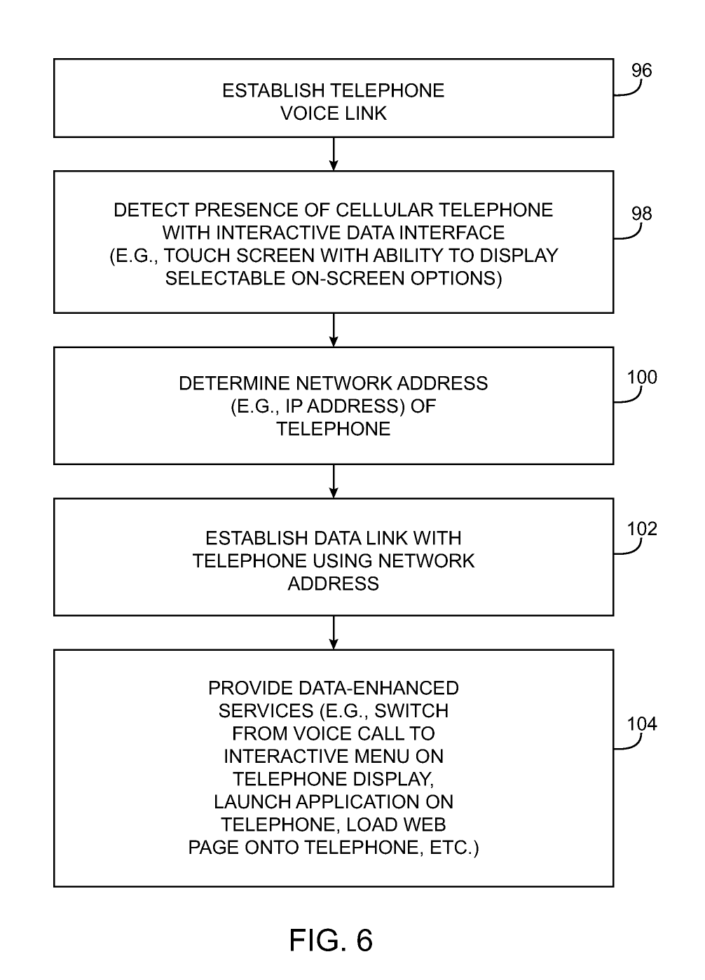

Illustrative steps involved in using system 10 are shown in FIG. 6.

At step 96, a user of cellular telephone 12 may place a voice call to a voice telephone number. The user may enter the telephone number using a keypad or touch screen in cellular telephone 12 or other suitable user interface. When the call is placed, a voice link is established between service 22 of cellular telephone 12 and service 42 at server 20 over network 14 (i.e., over voice network 34).

At step 98, the presence of a voice link with a cellular telephone that is capable of displaying data on a cellular telephone display and that is otherwise capable of handling data link functions is detected. The detection operations of step 98 may include, for example, detecting whether the cellular telephone is capable of maintaining a data link in data network 36, detecting whether the cellular telephone has a display capable of displaying web pages, detecting whether the cellular telephone is capable of receiving data packets that are addressed to a particular IP address or other network address, detecting whether the cellular telephone is capable of receiving web pages and other information in the form of data packets while simultaneously maintaining a voice link, etc. These capabilities and/or other capabilities such as these may be considered optional, may be considered mandatory, or may be given different weights in assessing whether to proceed with providing data-based services.

During the operations of step 98, service 42 may use caller ID to determine the telephone number of the calling telephone. Using this caller ID information, service 42 may determine that the user has previously registered the cellular telephone with service 42 and that the telephone is capable of supporting data links. As another example, audible signals such as audio codes may be conveyed between cellular telephone 12 and service 42 over the voice link to establish the capabilities of telephone 12.

At step 100, service 42 may determine the IP address of cellular telephone 12. For example, service 42 may request that this information be supplied to service 42 by the user's service provider (e.g., the telephone company from which the user has purchased voice and data services and/or the carrier that operates cellular base station 30 and therefore has knowledge of the IP address). If desired, the process of determining the IP address may be performed by looking up the IP address in a list of IP addresses. This list of addresses may be maintained by a network address registration service such as service 40 (e.g., a service to which telephone 12 periodically uploads information on its current IP address). A user identifier such as the telephone number associated with telephone 12 or other user identification information may be used in looking up the IP address at service 40. If the telephone number obtained by service 42 using the caller ID function is used during the IP address look-up process, the operations of steps 98 and 100 may be combined into a single step.

At step 102, service 42 and cellular telephone 12 establish a data link through network 14 (i.e., a link through data network 36). The IP address of cellular telephone 12 that was obtained during the operations of step 100 may be used in establishing the data link.

Once the data link has been established, service 42 may be used to provide data services to the cellular telephone (step 104). These services involve delivering information to cellular telephone 12 over the data link. Cellular telephone 12 typically has a display, so the information that is delivered during the operations of step 104 typically includes cellular telephone display screen data to be displayed on the cellular telephone display. The data that is delivered may also include information in the form of web pages, in the form of other visual information, in the form of other interactive cellular telephone display screen data such as selectable on-screen options data, in the form of streaming media, downloadable applications, remote access sessions, etc. The initial voice link may, if desired, be maintained while providing data link services. As described in connection with FIGS. 2, 3, 4, and 5, the data link between service 42 and service 22 may be used to present screens of interactive on-screen options for the user. When these options are selected, actions may be taken to deliver information, to consummate purchase transactions, to establish new voice links or voice-over-IP links, etc.

The foregoing is merely illustrative of the principles of this invention and various modifications can be made by those skilled in the art without departing from the scope and spirit of the invention.

What is claimed is:

1. A method of using a service that is implemented on computing equipment to communicate with a cellular telephone, comprising:
with the service, receiving a voice telephone call from a cellular telephone over a voice link in a voice network; and
in response to receiving the voice telephone call, detecting with the service whether the cellular telephone is capable of maintaining a data link with the service over a data network; and
in response to detecting that the cellular telephone is capable of maintaining the data link, transmitting data from the service to the cellular telephone over the data link using a network address associated with the cellular telephone.

2. The method defined in claim 1 wherein detecting whether the cellular telephone is capable of maintaining the data link comprises detecting whether the cellular telephone can receive internet protocol (IP) packets of data.

3. The method defined in claim 1 wherein detecting whether the cellular telephone is capable of maintaining the data link comprises generating audio codes.

4. The method defined in claim 1 wherein detecting whether the cellular telephone is capable of maintaining the data link comprises transmitting audio codes from the service to the cellular telephone over the voice link in the voice network.

5. The method defined in claim 1 wherein detecting whether the cellular telephone is capable of maintaining the data link comprises receiving audio codes at the service from the cellular telephone over the voice link in the voice network.

6. The method defined in claim 1 wherein detecting whether the cellular telephone is capable of maintaining the data link comprises using a caller identification service.

7. The method defined in claim 6 wherein using the caller identification service comprises ascertaining a cellular telephone number associated with the cellular telephone and wherein detecting whether the cellular telephone is capable of maintaining the data link comprises using the cellular telephone number to perform a database lookup operation to determine whether the cellular telephone that is associated with the cellular telephone number is capable of maintaining the data link.

8. The method defined in claim 1 wherein transmitting the data from the service to the cellular telephone comprises transmitting cellular telephone display screen information.

9. The method defined in claim 1 wherein transmitting the data from the service to the cellular telephone comprises transmitting web pages.

10. The method defined in claim 1 wherein transmitting the data from the service to the cellular telephone comprises transmitting interactive on-screen options.

11. The method defined in claim 10 further comprising:
in response to user selection of one of the interactive on-screen options, transmitting additional data from the service to the cellular telephone over the data link.

12. The method defined in claim 11 wherein transmitting the interactive on-screen options comprises transmitting interactive product ordering on-screen options.

13. The method defined in claim 11 wherein transmitting the interactive on-screen options comprises transmitting product support options.

14. The method defined in claim 11 wherein transmitting the interactive on-screen options comprises transmitting telephone directory options.

15. The method defined in claim 11 wherein transmitting the interactive on-screen options comprises transmitting credit card activation options.

16. The method defined in claim 1 wherein transmitting the data from the service to the cellular telephone over the data link comprises transmitting remote access session data associated with a remote access session for the cellular telephone.

17. The method defined in claim 1 wherein the network address comprises an internet protocol address, the method further comprising:
obtaining the internet protocol address of the cellular telephone for the service from another service over a network.

18. A method, comprising:
with computing equipment at an organization, receiving a voice telephone call from a cellular telephone over a voice link in a voice network; and
in response to receiving the voice telephone call, automatically transmitting interactive cellular telephone display screen data to the cellular telephone from the server over a data link in a data network.

19. The method defined in claim 18 wherein the interactive cellular telephone display screen data comprises on-screen menu options for display on the cellular telephone, the method further comprising:
identifying an internet protocol address of the cellular telephone; and
when transmitting the interactive cellular telephone display screen data, using the internet protocol address.

20. The method defined in claim 19 wherein identifying the internet protocol address of the cellular telephone comprises obtaining the internet protocol address from a network address registration service implemented on computing equipment over a network.

21. The method defined in claim 19 wherein identifying the internet protocol address of the cellular telephone comprises obtaining the internet protocol address from a telecommunications service provider.

22. The method defined in claim 18 further comprising:
at the cellular telephone, displaying the interactive cellular telephone display screen data on a display in the cellular telephone, wherein the interactive cellular telephone display screen data includes at least one option for ordering a product.

23. Apparatus that is coupled to a voice network and a data network, comprising:
a first server that is configured to receive a voice telephone call from a cellular telephone over a voice link in the voice network, wherein the cellular telephone has an associated internet protocol address at which data is received over a data link in the data network; and
a second server that is configured to store internet protocol addresses for a plurality of wireless devices including the internet protocol address of the cellular telephone, wherein the first server is configured to automatically transmit interactive on-screen options data to the cellular telephone for display on the cellular telephone from the first server over a data link in the data network using the internet protocol address of the cellular telephone that is stored by the second server.

24. The apparatus defined in claim 23 wherein the first server is configured to automatically obtain the internet protocol address of the cellular telephone from the second server in response to receiving the voice telephone call.

25. The apparatus defined in claim 24 wherein the cellular telephone has an associated cellular telephone number and wherein the first server is configured to use a caller identification service to ascertain the cellular telephone number.

26. The apparatus defined in claim 25 wherein the first server is configured to use the cellular telephone number in automatically obtaining the internet protocol address of the cellular telephone from the second server.

27. The apparatus defined in claim 23 wherein the voice network comprises a public switched telephone network, and wherein the first server is configured to receive the voice telephone call from the cellular telephone over the public switched telephone network.
